(19) United States
(12) Patent Application Publication
(10) Pub. No.: US 2007/0086183 A1
(43) Pub. Date: Apr. 19, 2007

(54) Children's dental mirror

(76) Inventors: Gregory J. Foster, Chicago, IL (US); Robert W. Sheldon, Winnetka, IL (US)

Correspondence Address: Paul E. Schaafsma, NovusIP, LLC, Suite 221, 521 West Superior Street, Chicago, IL, 60610-3135, US

(21) Appl. No.: 11/507,855

(22) Filed: Aug. 22, 2006

Related U.S. Application Data
(60) Provisional application No. 60/711,789, filed on Aug. 26, 2005.

(51) Int. Cl. F21V 33/00

(52) U.S. Cl. 362/135

(57) ABSTRACT

The present invention provides a children's dental mirror. The children's dental mirror includes a mirror and an integral timer. At least one light can be provided that pulsates to a timer. An audio sound byte can be provided that is governed by a timer.

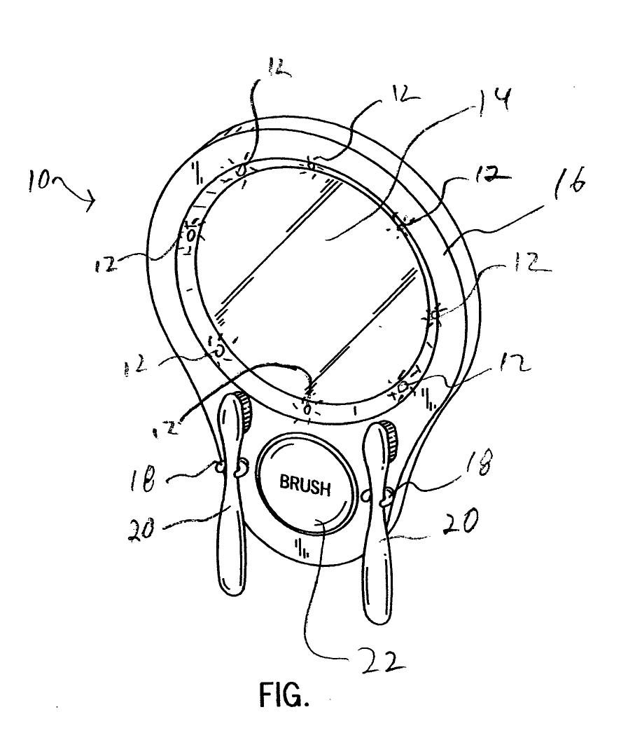

### CROSS-REFERENCE TO RELATED APPLICATIONS

This application is based on U.S. Provisional Patent Application Ser. No. 60/711,789 titled, “Mirror,” filed 26 Aug. 2005.

### FIELD OF THE INVENTION

The present invention relates to dental devices.

### BACKGROUND OF THE INVENTION

Teeth are covered with a sticky film of bacteria, called plaque. Within this film live thousands of different types of bacteria. Of all these many different types of bacteria, one causes tooth decay: that bacterium is called Strep Mutans.

After eating a meal, small crumbs of food are left in mouths. The Strep Mutans bacteria eat these crumbs and produce harmful acid. This acid can attack tooth enamel for as long as 20 minutes or more. Repeated acid attacks cause the enamel of the teeth to break down, resulting in tooth decay.

If left untreated, the decay will continue to progress through the tooth structure until it reaches the pulp. The pulp chamber houses the nerve and blood supply for the tooth. When decay reaches the pulp, an abscess ensues which is associated with tremendous pain. Once the decay is in the chamber, the only choice of treatments are root canal therapy or extraction of the tooth.

The best way to prevent decay from forming is by cleaning mouths, thus removing the stray bits of food. If there is no food for the Strep Mutans bacteria to digest, then the bacteria cannot create the acid needed to cause decay.

While most people know that brushing their teeth is important, very few brush their teeth the appropriate amount of time. Most brushers over-estimate how long they have been brushing their teeth which results in under-brushing. However, even those who do not under-brush their teeth may be harming their teeth. This is because brushing too long brushing for too long can lead to gum disease and tooth decay as the enamel is brushed off.

A study by the England's University of Newcastle upon Tyne's School of Dental Sciences found that young adults spent less than 35 seconds brushing their teeth. McCracken, G. I., Janssen, J., Swan, M., Steen, N., de Jager, M. & Heasman, P. “The effect of brushing force and time on plaque removal using a powered toothbrush.” Journal of Clinical Periodontology. 2003, 30, 409-413. “Once you go beyond approximately that point you aren't being any more effective than if you had stopped,” said Peter Heasman, professor of periodontology (the study of structures surrounding and supporting teeth) at Newcastle. “You could actually be harming your gums and possibly your teeth.”

These issues can even be more acute in children's teeth. Many parents assume that decay does not matter in primary teeth because the teeth will fall out anyway, but decay in primary teeth poses risks. If a child loses his primary teeth too early because of decay or infection, the permanent teeth will not be ready to erupt. Primary teeth act as a guide for the permanent teeth: if primary teeth are lost too early, the teeth that are left may tip or move into the vacant space. When the permanent teeth are ready to come into the mouth, there may not be enough room. As a result, teeth may erupt out of their proper positions, leading to malocclusion, crooked or crowded. In addition, the primary teeth help a child learn proper speech.

Even if a parent is properly informed, when left to their own devices children are even worst at estimating the proper amount of time to brush their teeth. What is thus needed is device to encourage children to brush their teeth the proper amount of time. This device should be as interesting and as entertaining to the child as practicable.

### SUMMARY OF THE INVENTION

A device in accordance with the principals of the present invention encourages children to brush their teeth the proper amount of time. A device in accordance with the principals of the present invention is interesting and entertaining to the child to encourage proper brushing. In accordance with the principals of the present invention a dental mirror for children is provided. The children's dental mirror includes a mirror and an integral timer. At least one light can be provided that pulsates to a timer. An audio sound byte can be provided that is governed by a timer.

### BRIEF DESCRIPTION OF THE DRAWINGS

The FIGURE is perspective view of a dental mirror in accordance with the principles of the present invention.

### DETAILED DESCRIPTION OF THE INVENTION

The FIGURE shows a children's dental mirror 10 in accordance with the principles of the present invention. A children's dental mirror 10 of the present invention incorporates a timer integrated with it. In one embodiment, the timer is between about two and about three minutes. In one embodiment, the timer is about two minutes. A children's dental mirror 10 of the present invention provides children a station to provide feedback and entertainment while brushing their teeth. The children's dental mirror can also have lights 12 around the circumference of a mirror 14 that can pulsate to the timer. In one embodiment, in addition to the pulsating lights the device can provide an audio sound byte during the brushing period. The timer can have several audio sound bytes and be changed by a sliding switch. The timer, lights, and sound can be power by battery. Thus, a children's dental mirror 10 of the present invention offers children an interaction device with a selection of audio sound bytes that when engaged will sound for a given period of time accompanied by a series of lights 12 integrated around the peripheral of the mirror 14.

In more detail, in one embodiment an elliptical shaped children's dental mirror 10 having an image enlarging mirror 14 is provided. The image maximizing mirror 14 can have an enlargement of from about 2 to about 5 times the image to maximize the reflection of the face/mouth yet minimize the overall physical size of the children's dental mirror. In one embodiment, housing 16 for the mirror can be made of non-breakable material such as for example a “rubberized” plastic material. An oversized on button 22 can be provided for ease of use by children.

A keyhole can be defined on the back of the of the children's dental mirror 10 for hanging. In one embodiment, suction cup fasteners can be provided on the back of the children's dental mirror 10 to allow for a simple and flexible fastening and height adjustment system. The children's dental mirror 10 can then be placed directly in the child's sight line.

The unit can be powered by battery and can be water-resistant. A battery door can be provided on the back of the children's dental mirror 10 to replenish the power supply. The mirror can also has two integral toothbrush holders 18 that are designed to hold toothbrushes 20 and an optional keyhole slot for traditional nail hanging.

It should be understood that various changes and modifications to the preferred embodiments described herein would be apparent to those skilled in the art. Such changes and modifications can be made without departing from the spirit and scope of the present invention and without diminishing its attendant advantages. It is therefore intended that such changes and modifications be covered by the appended claims.

What is claimed is:

1. A children's dental mirror comprising a mirror and an integral timer.

2. The children's dental mirror of claim 1 further wherein the timer is between about 2 and about 3 minutes.

3. The children's dental mirror of claim 2 further wherein the timer is between 2 and 3 minutes.

4. The children's dental mirror of claim 1 further including at least one light that pulsates to the timer.

5. The children's dental mirror of claim 4 further including a plurality of lights around the circumference of the mirror that pulsate to the timer.

6. The children's dental mirror of claim 1 further including an audio sound byte.

7. The children's dental mirror of claim 6 further including a plurality of audio sound bytes that can be selected.

8. The children's dental mirror of claim 1 further wherein the mirror is an image enlarging mirror.

9. The children's dental mirror of claim 1 further wherein the mirror is made of non-breakable material.

10. The children's dental mirror of claim 1 further including suction cup fasteners provided on the back.

11. The children's dental mirror of claim 1 further including at least one integral toothbrush holder.

12. A children's dental mirror comprising a mirror and at least one light that pulsates to a timer.

13. The children's dental mirror of claim 12 further wherein the timer is between about 2 and about 3 minutes.

14. The children's dental mirror of claim 13 further wherein the timer is between 2 and 3 minutes.

15. The children's dental mirror of claim 12 further including a plurality of lights around the circumference of the mirror that pulsate to the timer.

16. The children's dental mirror of claim 12 further including an audio sound byte.

17. The children's dental mirror of claim 16 further including a plurality of audio sound bytes that can be selected.

18. The children's dental mirror of claim 12 further wherein the mirror is an image enlarging mirror.

19. The children's dental mirror of claim 12 further wherein the mirror is made of non-breakable material.

20. The children's dental mirror of claim 12 further including suction cup fasteners provided on the back.

21. The children's dental mirror of claim 12 further including at least one integral toothbrush holder.

22. A children's dental mirror comprising a mirror and an audio sound byte governed by a timer.

23. The children's dental mirror of claim 22 further wherein the timer is between about 2 and about 3 minutes.

24. The children's dental mirror of claim 23 further wherein the timer is between 2 and 3 minutes.

25. The children's dental mirror of claim 22 further including at least one light that pulsates to the timer.

26. The children's dental mirror of claim 25 further including a plurality of lights around the circumference of the mirror that pulsate to the timer.

27. The children's dental mirror of claim 22 further including a plurality of audio sound bytes that can be selected.

28. The children's dental mirror of claim 22 further wherein the mirror is an image enlarging mirror.

29. The children's dental mirror of claim 22 further wherein the mirror is made of non-breakable material.

30. The children's dental mirror of claim 22 further including suction cup fasteners provided on the back.

31. The children's dental mirror of claim 22 further including at least one integral toothbrush holder.
